(19) United States
(12) Patent Application Publication
(10) Pub. No.: US 2015/0151147 A1
(43) Pub. Date: Jun. 4, 2015

(54) Powered adaptor for respirator masks

(71) Applicant: Wey Fun, Singapore (SG)

(72) Inventor: Wey Fun, Singapore (SG)

(21) Appl. No.: 14/095,983

(22) Filed: Dec. 3, 2013

(51) Int. Cl. A62B 18/00; A62B 18/02; A41D 13/11; A62B 23/02

(52) U.S. Cl. CPC A62B 18/006; A62B 23/025; A62B 18/02; A41D 13/11

(57) ABSTRACT

An apparatus for use as an aid to using respirator mask. The apparatus includes a mounting module for mounting the replaceable mask at a clearance distance from the user's face so as to create an air chamber for storing the air for the user to breathe. At least one powered fan is mounted in the mounting module for removing the exhaled air and sucking in fresh air into the air chamber so that the user does not need to spend additional energy to overcome the resistance to air flow due to the filtration in the mask.

### REFERENCES CITED

U.S. Patent Documents

| | | |
|---|---|---|
| 7,077,137 B2 | Jul. 18, 2006 | James K. Russell |
| 6,257,235 | Jul. 10, 2001 | Michael L. Bowen |
| 6,854,464 | Feb. 15, 2005 | Mukaiyama et al. |
| 7,464,705 | Dec. 16, 2008 | Tanizawa et al. |
| 4,233,972 | Nov. 18, 1980 | Hauff et al. |
| 8,375,950 B2 | Feb. 19, 2013 | Bostock et al. |

### FIELD OF THE INVENTION

The present invention relates, in general, to breathing protective device.

In particular, this invention relates to a powered adaptor for facial masks and respirators with replaceable air filtering cartridges.

### BACKGROUND OF THE INVENTION

Face masks are being used by millions of people around the world for either protecting own respiratory system from foreign particles in the air (with the use of respirator masks), or for preventing own exhaled material from contaminating the environment (with the use of surgical mask). However the typical passive masks require the user to generate significantly higher vacuum in order to suck in the required among of filtered air because the suction needs to overcome the resistance of airflow through the filter. Even worse is that the exhaled gas is mostly trapped in the masked volume, and the user's inhalation mostly takes in the exhaled gas within the mask. Such lack of fresh air causes nausea and discomfort among vulnerable users such as those with chronic respiratory problems, elderly people and young children.

There had been attempts to ease the release of exhaled gas from the mask. An approach commonly adopted is with the inclusion of a one-way exhalation release valve such as the 3M's ‘Cool Flow’ valve. However such use of the valve only marginally improves the comfort of using it as it still requires expending strength of breathing to force the valve to open during exhalation. Moreover the inclusion of such a valve in each unit of disposable mask would significantly increase the price of the mask.

There are also a large variety of powered and supplied air respiratory systems available in the market. Examples are the 3M's Versaflo and Powerflow 7900 PF systems. However these systems are typically bulky and expensive and not for the consumer market. U.S. Pat. Nos. 6,854,464, and 7,464,705 and 4,233,972 also describe various forms of powered respirators that involve the use of electric fans to overcome the resistance to air flow in the filtration elements.

In particular, U.S. Pat. No. 6,257,235 describes an invention of a face mask with a fan attachment to enhance the breathability and comfort of the mask. However this invention has numerous drawbacks. Firstly it requires a special mask designed with an interface to secure the fan onto it, which is different from the traditional face masks currently available in the market. This implies that the popular disposable masks cannot be used unless significant modification is carried out. Secondly the fan is located near the bottom of the mask which implies that those hot exhaled gas not immediately sucked out by the fan would rise and be trapped in the air chamber near top of the mask. Thirdly the exhaled gas is also directly blown towards the mask and its moisture and heat could be retained in the filter media of the mask and eventually returns along with the filtered air. Having moisture trapped in the filter would negatively affect the effectiveness of the filter. Fourthly the mask is soft and conforming and this could cause the fan to move too close to the wearer's face and thereby not giving sufficient clearance for the fan to function properly.

### SUMMARY OF THE INVENTION

The present invention seeks to provide an improved respiratory aid that could greatly alleviate the difficulty inherent with overcoming the resistance against air flow through the air filter while not requiring the user to change his breathing method. The air filter could be face mask that blocks the particles or organic materials suspended in the air with electrostatics and/or interception and diffusion by the fibres, or replaceable cartridge type with active chemical components such as 3M's 6001 Organic Vapor Cartridge that could neutralize the active harmful chemicals in the air. The mask could be respirator type that prevents the harmful particles from the environment reaching the user's respiratory system, or the surgical type that prevents that harmful material generated from within the user's respiratory system from reaching the environment. In the following description all these air filters will be referred to as ‘mask’.

The target is to create a device that could work along with the passive masks currently available in the market, and it allows the user to breathe as easily as if he is not wearing the mask while getting the full benefit of using it.

It comes in the form of a powered adaptor for the masks currently available in the market, is compact in size and light in weight and not significantly larger than the typical disposable mask currently being used.

It utilizes two commonly available components: the portable battery pack developed for mobile phones' charging, and micro-size fans developed for cooling electronic components. The use of such low-cost matured components makes the apparatus affordable to the consumers.

The simplified form of the device basically consists of a mounting module that has receptive means for securely attaching a mask onto it and also allows it to be properly mounted onto the user's face in air-tight manner. The purpose of this mounting module is to create an air chamber bounded by its wall, the mask and the user's face.

The mounting module has an air vent at the top portion, with a fan mounted on it so that the air can be blown into or out of the air chamber in the mounting module. The fan could be a suction or blower type depending on the usage of the apparatus. If the apparatus were to be used with the respirator mask, the fan would be of suction type that helps in removing the exhaled gas trapped within the air chamber, while also create vacuum that helps in sucking in fresh air from outside the device through the mask. If the apparatus were to be used with the surgical mask then the fan would be blower type that blows the air from outside through the vent into the air chamber, while forcing the exhaled gas from the user through the surgical mask.

For use with the respirator mask, it is also essential to add a deflector in the mounting module positioned in-between the mask and the user's face. The purpose of this deflector is to prevent most of the exhaled gas from reaching the mask and thereby leaving the heat and humidity inside the filter. Another function of the deflector is to detour the exhaled gas to the vent and be effectively sucked out of the air chamber by the fan. In this way the contamination of filtered air inside the air chamber by the exhaled gas could be minimized.

The power to the fan could be manually adjusted by the user via a switch to achieve comfortable level of air flow rate.

The air vent could also be covered with a lid. In this way the user could continue using the mask with the adaptor even if the fan fails to operate due to faulty circuit or depletion of battery power.

This invention has numerous advantages over the prior arts. Firstly the apparatus only needs common masks currently available in the market and this eradicates the need for special-produced masks. This makes the apparatus cost-effective because its disposable component is relatively low-cost and can be easily acquired. Secondly the mounting module provides a rigid structure that maintains sufficient clearance between the fan and the user's face so that the fan is able to function properly. Thirdly the fan is mounted near the top portion of the mask to ensure that all the hot exhaled gas can be removed by the fan and not be trapped inside the upper volume of the air chamber in the mask. Fourthly the deflector in the mounting module prevents much of the exhaled gas from being directly blown from the nose into the mask, thereby drastically reduces the amount of heat and moisture being retained in the filtration media and returns along with the filtered air. The reduction in the amount of exhaled moisture being trapped in the filter contributes to the maintenance of the effectiveness of the filter. It also acts as a partial partition screen and reduces the contamination of filtered air inside the air chamber by the exhaled gas.

### BRIEF DESCRIPTION OF THE DRAWINGS

A preferred embodiment of the present invention will now be more fully described, by way of example, with reference to the drawings of which:

FIG. 1 illustrates an embodiment of the basic design with showing how the apparatus would be worn by the user;

FIG. 2 illustrates the details of an embodiment for use with respirator mask, where there is only one fan at the exit vent sucking the exhaled gas out and aiding in sucking in filtered air through the mask into the air chamber;

FIG. 3 illustrates the details of the face mount of the preferred embodiment.

FIG. 4 illustrates with a cross-sectional view the flow of exhaled gas inside the air chamber during the user's exhalation for the respirator configuration;

FIG. 5 illustrates with a cross-sectional view the flow of filtered air inside the air chamber during the user's inhalation for the respirator configuration.

### DETAILED DESCRIPTION OF THE INVENTION

A detailed description of the present invention will now be given in accordance with a preferred embodiment of the invention. In the following description, details are provided to describe the preferred embodiment. It shall be apparent to one skilled in the art, however, that the invention may be practiced without such details. Some of these details may not be described at length so as not to obscure the invention.

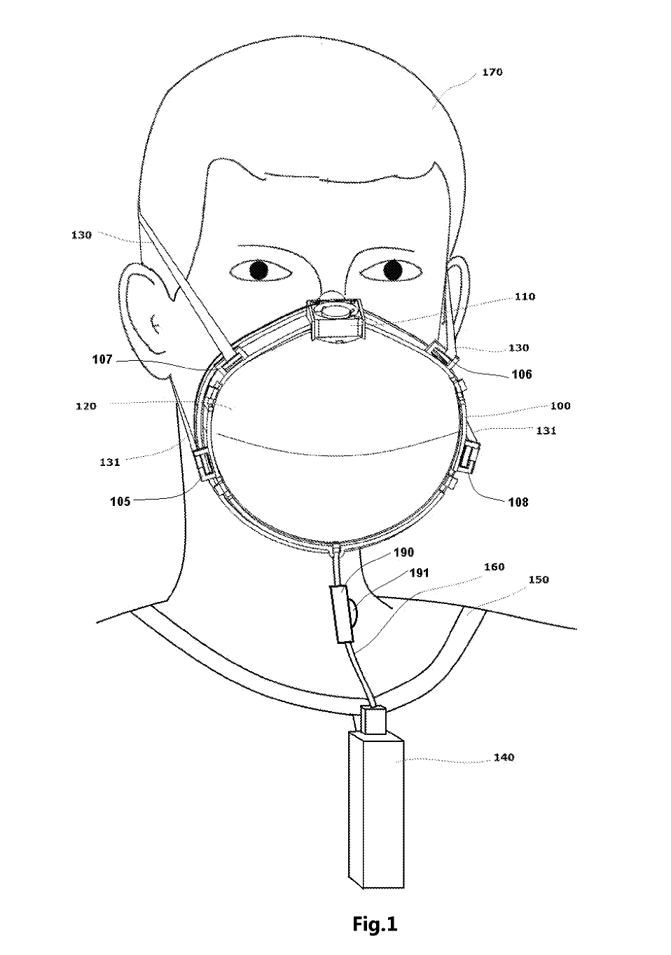

The present invention is generally aimed at providing a device that aids the user of face mask in overcoming the discomfort caused by the resistance in air flow due to the presence of filter. The generic embodiment is as shown in FIG. 1, which illustrates a user 170 wearing the apparatus comprising the mounting module 100, the outer fan 110, the mask 120, the upper harness strap 130 and lower harness strap 131 that secure the mounting module 100 onto the user's head, the power cable 160 that connects the outer fan 110 to the power supply unit 140, and the lanyard 150 that allows the power supply unit 140 to be worn around the user's neck. The strength of power supply to the outer fan 110 can be manually adjusted via the control switch 190.

The mounting module 100 also has four harness slots 105, 106, 107 and 108 that are used for securing the two elastic harness straps 130 and 131, and these are in turn used to secure the apparatus to the user's head. The upper harness strap 130 is tied onto the harness slot 106 on the left end and onto harness slot 107 on the right end, while the lower harness strap 131 is tied onto the harness slot 105 on the left end and onto harness slot 108 on the right end.

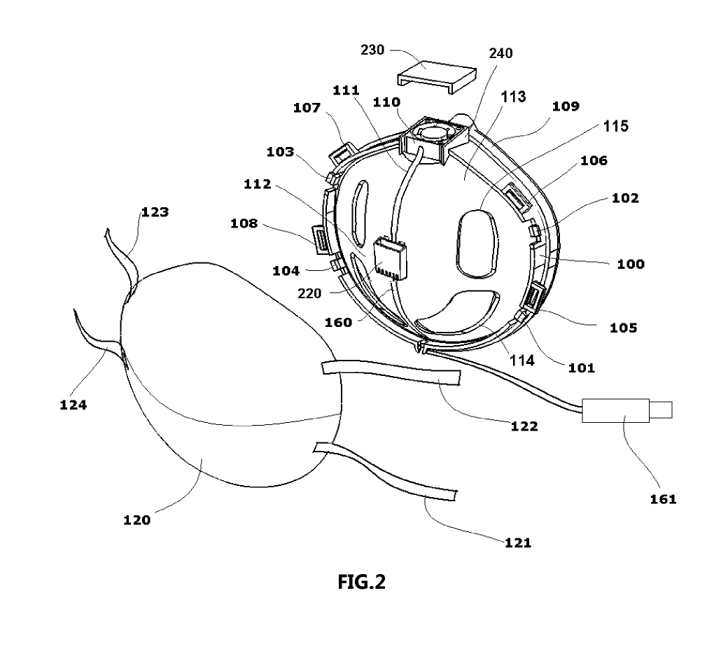

Referring now to FIG. 2 that shows the details of the mounting module 100 and the manner by which the mask 120 is mounted onto the mounting module 100. This particular embodiment is for the apparatus to be used with the respirator mask.

The mounting module 100 has a mask interface 113 that allows the outer rim of the mask 120 to be tightly conformed onto, such that an air-tight interface between them can be achieved. The middle of this mask interface 113 is the deflector 112, whose function is to detour the exhaled gas from the user towards the outer fan 110, and also to prevent most of the exhaled gas from reaching the mask 120 which otherwise would result in its heat and moisture being retained in the filter substrate of mask 120 and return along with the filtered air.

The mask interface 113 is flatter than the mask 120 so that when the latter is mounted onto the former there is a substantial gap in-between the two and only a small area near the rim of the mask 120 is in contact with the mask interface 113. This clearance ensures that much of the filtration surface of the mask 120 is functioning. The mask interface 113 also has numerous windows such as 114 and 115 that allow the filtered air from the mask 120 to flow around the deflector 112 and reach the user's nose.

The mask 120 available in the market comes with elastic harness braids for securing onto the user's face. They are usually in the form of upper and lower rings. For the mask 120 to be mounted to the mounting module 100, the upper ring is cut into two separate portions upper-left braid 122 and upper-right braid 123, while the lower ring is cut into lower-left braid 121 and lower-right braid 124. The upper-left braid 122 is then wrapped around the upper-left notch 102 on the mounting module 100. Similarly upper-right braid 123 is wrapped around upper-right notch 103, lower-left braid 121 is wrapped around lower-left notch 101, lower-right braid 124 is wrapped around lower-right notch 104. The upper-left braid 122 is then tied and knotted with lower-left braid 121 around the rim of mounting module 100, while the upper-right braid 123 is tied and knotted with lower-right braid 124.

The mounting module 100 has an air vent 240 near the top where the user's nose is supposed to be located. The outer fan 110 is secured at the exit top end of this air vent 240. The air vent 240 could be covered up with the use of a lid 230. This would close the air chamber so that the apparatus could still function as an air filter in case the outer fan 110 fails to operate due the reasons such as depletion of battery power. The power cable 160 of the outer fan 110 is secured along the slot 111 on the mask interface 113.

The mounting module 100 also could have an optional pin-holed container 220 that stores and gradually releases fragrance essence into the filtered air in the air chamber. This is to enhance the utilization of the apparatus by providing the additional option to the user. The fragrance essence could be liquid type and stored in cotton blob housed in the container 220. It could also be solid type and be directly slotted into the container 220. The mounting module 100 also has a soft compliant face mount 109 at the rear that snugly fits onto the user's face.

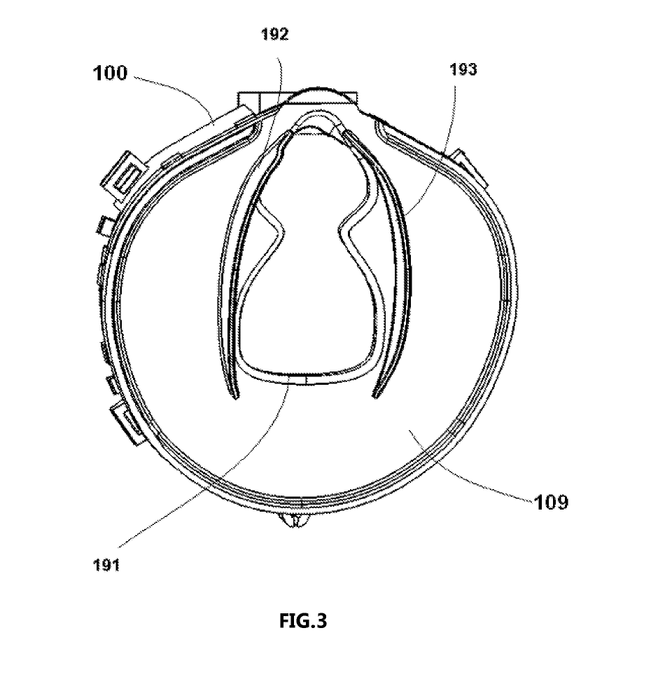

Referring now to FIG. 3 that shows the details of the face mount 109. The face mount 109 is made of soft compliant material such as silicone rubber or santoprene. It is securely coupled at the rear of the mounting module 100 and has an inner cavity 191 that suits the user's facial contour around the nose-mouth area and allows the user's nose and mouth to pass through the facial mount 109. It also has a left vertical flap 192 and a right vertical flap 193 located on the respective sides of the inner cavity 191. They are designed to conform around the nose and cheek area of the user. When the user secures the device on his face, the tension in the elastic harness straps 130 and 131 would ensure that his nose-mouth area is pushed against the inner cavity 191. This causes the rim around inner cavity 191 being bent in the direction away from the user's face, while the vertical flaps 192 and 193 are bent sideway in left and right directions respectively by the nose and cheek of the user. Such counter-rotating bending forces, combined with the compliant property of the material, would ensure that the apparatus is air-tightly mounted onto typical human's face whose contour could vary within reasonable limits.

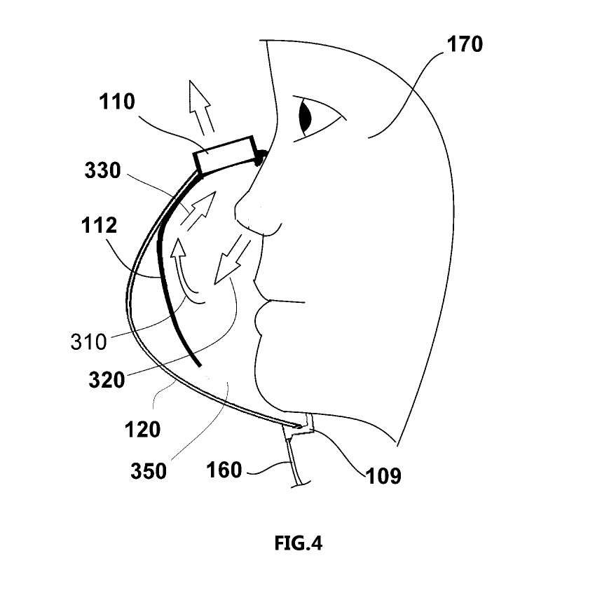

Referring now to FIG. 4 that illustrates with a cross-sectional view the flow of exhaled gas inside the air chamber during the user's exhalation for the respirator configuration. When the user 170 exhales, the exhaled gas being blown in the direction 320 towards the mask 120 is deflected by the deflector 112 and flows along the direction 310, and eventually along direction 330 into the outer fan 110 and expelled out of the apparatus.

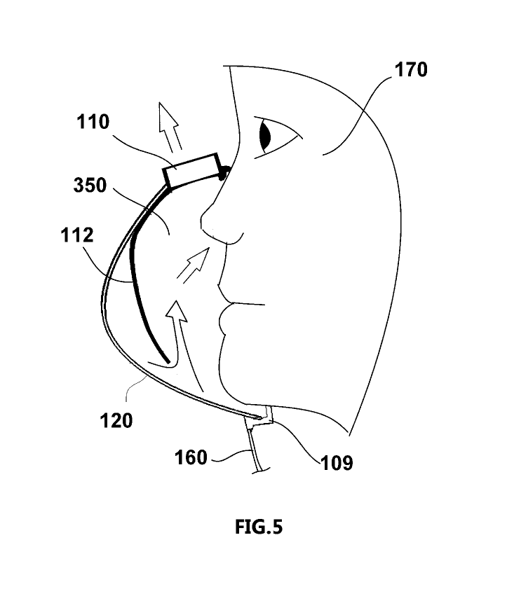

Referring now to FIG. 5 that illustrates with a cross-sectional view the flow of filtered air inside the air chamber during the user's inhalation for the respirator configuration. The filtered air is being sucked into the air chamber 350 and flows around the deflector 112 into the space around the user's nose before being expelled out of the apparatus by the outer fan 110. This ensures that the user 170 could consume the fresh filtered air as his nose is along the flow path.

It will be appreciated that although one preferred embodiment has been described in detail, various modifications and improvements can be made by a person skilled in the art without departing from the scope of the present invention.

1. An apparatus for use by a user as adaptor for an air filter comprising a mounting module and an outer fan;
said mounting module further comprising an air vent positioned near to where the nose of said user would be located;
said outer fan is securely mounted along the said air vent;
said mounting module further comprising an interface for securing the said air filter in a manner that the rim of said air filter is completely in contact with the said interface. Said interface is positioned in the said mounting module in a manner to achieve suitable spatial separation between the said air filter and the user's face, such that an air chamber bounded by the inner wall of the said mounting module, the said air filter and the face of said user is created and the only way the air could flow in or out of said air chamber is via the said air vent.

2. The apparatus of claim 1, wherein the said outer fan is connected to a power supply via a wire and a power switch.

3. The apparatus of claim 1, wherein the said mounting module further comprising a facial mount with inner cavity fitting the contour of the nose-mouth area of the said user. Said facial mount is securely coupled to said mounting module along their outer rims. Said facial mount is made of soft compliant material to enhance the air-tightness of the said air chamber. Said inner cavity allows the nose and mouth of said user to pass through the said facial mount.

4. The apparatus of claim 3, wherein the said facial mount further comprising a left vertical flap and a right vertical flap located on the left and right sides respectively of the said inner cavity. Said left vertical flap is bent left-ward and said right vertical flap is bent right-ward by the nose and cheek of the said user when the apparatus is mounted onto the face of said user.

5. The apparatus of claim 1, wherein the said air filter is a respirator type; and the said outer fan is of suction type that sucks air through the said air filter into the said air chamber and expels the exhaled gas from the said user out of the said air chamber through the said air vent.

6. The apparatus of claim 5, wherein the said interface is a deflector positioned in-between the said air filter and the face of said user such that the exhaled gas from the said user is blocked from directly being blown into the said air filter and be effectively channeled to the said outer fan and subsequently expelled out through the said air vent. Said deflector further comprising windows near and around its peripheral for the filtered air to flow from the said air filter to the nose of said user.

7. The apparatus of claim 1, wherein the said air filter is of surgical type; and the said outer fan is of blower type that sucks air from outside and blows the air into the said air chamber through the said air vent.

8. The apparatus of claim 2, wherein the said power switch is a variable type.

9. The apparatus of claim 1, wherein said mounting module further comprising a pin-holed container for storing and gradually releasing fragrance essence to the filtered air in the said air chamber.

10. The apparatus of claim 1, wherein said air vent further comprising a receptacle for securing a lid for covering the said air vent so that the said air chamber is completely enclosed and the apparatus continues to function as an air filter.
